(19) United States
(12) Patent Application Publication
(10) Pub. No.: US 2023/0398554 A1
(43) Pub. Date: Dec. 14, 2023

(54) MICROFLOTATION SYSTEM FOR TREATING A BODY OF WATER

(71) Applicants: Volker DAMANN, Lichtenau-Henglarn (DE); Roland Damann, Paderborn (DE)

(72) Inventor: Roland Damann, Paderborn (DE)

(21) Appl. No.: 18/033,707

(22) PCT Filed: Oct. 27, 2021
(86) PCT No.: PCT/EP2021/079870

§ 371 Date: Apr. 25, 2023

(30) Foreign Application Priority Data
Nov. 2, 2020 (EP) 20205159.5

(51) Int. Cl. B03D 1/14; C02F 1/24; C02F 1/52; E02B 1/00; C02F 1/00

(52) U.S. Cl. CPC B03D 1/1431; C02F 1/24; C02F 1/52; E02B 1/003; C02F 1/008; C02F 2103/007

(57) ABSTRACT

A microflotation system for treating a body of water includes a pressure apparatus configured to produce pressurized water, an expansion valve positioned at a predefined water depth in the body of water and a pressurized water line configured to connect the pressure apparatus to the expansion valve. The system further includes a floating body and a supporting structure connected to the floating body and is structured to maintain the expansion valve at the predefined water depth. A base wall is coupled to the supporting structure and positioned below a surface of the body of water. A circumferential side wall is connected to the base wall and a microbubble stabilization zone is positioned downstream of the expansion valve and is at least partially delimited from the body of water by the base wall and the circumferential side wall.

### CROSS REFERENCE TO RELATED INVENTION

This application is a national stage application pursuant to 35 U.S.C. § 371 of International Application No. PCT/EP2021/079870, filed on Oct. 27, 2021, which claims priority to, and benefit of, European Patent Application No. 20205159.5, filed Nov. 2, 2020, the entire contents of which are hereby incorporated by reference.

### TECHNOLOGICAL FIELD

This disclosure relates to a microflotation system for treating a body of water.

### BACKGROUND

Microflotation systems are primarily utilized for treating industrial wastewater. Said microflotation systems have a flotation tank into which the wastewater to be treated is introduced. Microbubbles are produced inside the flotation tank, which attach themselves to impurities and, together with these, slowly rise to the surface. If necessary, a flocculant can be added. The foam which forms on the surface can simply be sucked off or skimmed off. In order to produce the microbubbles, part of the already treated wastewater is enriched at elevated pressure with a gas which ideally dissolves until a saturation concentration is reached. Said pressurized water travels via a line to an expansion valve where a sudden pressure release occurs. As a consequence of said pressure release, numerous microbubbles are created which ideally have a relatively uniform size in the range of approx. 30 μm to approx. 50 μm.

In order to treat a body of water, the process of erecting such a microflotation system on the banks of the body of water and of conducting the water to be treated from the body of water into the flotation tank is known. One example, which especially involves reducing the phosphate content of a body of water and accommodating the flotation tank in a container, is described in the printed document DE 44 33 634 C2. The tried-and-tested microflotation technology is readily suitable for such a utilization, but erecting the microflotation system on the banks together with the required lines is a complex process which is not very flexible.

A microflotation system located on board a ship, in which several expansion valves are arranged below the water surface in the body of water, has become known from the printed document DE 10 2010 026 168 A1. The microbubbles should rise behind the ship, and the flotate which is created on the water surface is to be conveyed into the ship with a special conveying apparatus.

A microflotation system, which has a floating body and can be arranged in a floating manner on the surface of a body of water, has become known from the printed document EP 3 647 272 A1. A series of expansion valves is arranged beneath the water surface. A barrier, inside which the flotate can be collected, is located close to the water surface. A similar system which floats on a body of water and is towed by a ship has become known from the printed document DE 10 2010 026 168 A1.

A device for producing microbubbles from liquids which have been exposed to pressurized gas, which has a hollow cone nozzle as the release body and a cover plate arranged downstream thereof, has become known from the printed document DE 37 33 583 A1.

A microflotation system comprising the features of the preamble of Claim 1 has become known from the printed document DE 690 03 470 T2.

### BRIEF SUMMARY OF THE INVENTION

Proceeding from this, it is the object of the invention to provide a microflotation system for treating a body of water, which makes possible a more efficient production of microbubbles.

An embodiment of a microflotation system includes an apparatus or pressure apparatus structured for producing pressurized water, an expansion valve arranged at a predefined water depth and a pressurized water line structured to connect the pressure apparatus and structured to produce pressurized water to the expansion valve. The system further includes a supporting structure structured to maintain the expansion valve at a predefined water depth. A microbubble stabilization zone arranged downstream of the expansion valve is delimited from the surrounding body of water by a base wall and a circumferential side wall connected thereto.

In an embodiment, the pressure apparatus for producing pressurized water can have a pressure vessel having a supply line for water and a feed line for gas, in particular air. A pump can be arranged in the supply line. A free end of the supply line can be arranged beneath the surface of the body of water. A compressor can in particular be arranged in the feed line for the gas. The water and gas are mixed with one another in the pressure vessel. The gas dissolves under elevated pressure in the water, preferably until such time as saturation is reached or almost reached.

As an alternative to the use of a feed line for the gas, which opens into the pressure vessel, a venturi injector can be arranged in the supply line for pressurized water, with which air is sucked in from the surroundings. In this case, water and gas are already blended in the feed line.

In an embodiment, the pressurized water produced can be removed from the pressure vessel via the pressurized water line and can be conducted to the expansion valve. The expansion valve is located at a predefined water depth and has at least one outlet opening, from which the pressurized water escapes. While the pressurized water flows through the expansion valve, the pressure decreases from the prevailing overpressure in the pressurized water line upstream of the expansion valve to the ambient pressure existing in the vicinity of the outlet opening (which is dependent on the water depth). A plurality of gas bubbles is formed during said pressure release process.

In an embodiment, the supporting structure maintains the expansion valve at a predefined water depth. It can optionally be fastened to a floating body of the microflotation system and can extend from there down to the desired water depth. Alternatively, the supporting structure can also be arranged on the bottom of the body of water and extend from there upwards to the desired water depth. The predefined water depth can be selected according to the respective requirements. In particular, the supporting structure can have an adjustment mechanism for fixing the expansion valve at different water depths.

The invention is based on the finding that the outlined pressure release process is not very effective when the expansion valve is arranged in an open body of water. In particular, it was observed that, in many cases, only very few microbubbles form in relation to the quantity of pressurized water introduced. It is presumed that the cause of this low efficiency lies with the high concentration gradient. Due to the low concentration of the gas dissolved in the surrounding water of the body of water, a large part of the microscopically small gas bubbles which form when the pressure is released is dissolved directly in the water. This seems to happen so quickly that no stable microbubbles, or only a few of them, are configured. In contrast to a conventional microflotation system, in which the pressurized water is introduced into a relatively small flotation tank, the water body of the body of water can absorb large quantities of the gas. Greater blending also occurs, because larger quantities of water are in constant exchange with the water in the vicinity of the expansion valve.

In an embodiment, the excessive concentration gradient is counteracted by a microbubble stabilization zone. Said microbubble stabilization zone is arranged downstream of the expansion valve, so that the gas/water mixture flows into the microbubble stabilization zone after passing through the expansion valve. The microbubble stabilization zone is distinguished by the fact that it is delimited from the surrounding body of water by a base wall and a circumferential side wall connected thereto. It is true that the water located in the microbubble stabilization zone is in constant exchange with the surrounding body of water, in particular because the microbubble stabilization zone is, as a general rule, open at the top, however the exchange is severely restricted by the indicated walls, and indeed both with regard to diffusion and flow processes. As a result, a concentration of the dissolved gas, which is higher than that in the surrounding body of water quickly, ensues in the microbubble stabilization zone. The microscopically small gas bubbles, which are created when the pressure is released, are therefore dissolved to a lesser extent in the surrounding water. As a result, there is sufficient time for the configuration of stable microbubbles, a large part of which ideally has diameters in the range from 20 μm to 60 μm, in particular in the range from 30 μm to 50 μm. Microbubbles of this size are relatively insensitive to a solution in the surrounding liquid due to their high internal pressure and their large volume compared to the surface (in relation to the microscopically small gas bubbles which are originally created). If said microbubbles flow out of the microbubble stabilization zone, in particular by slowly rising upwards, they can therefore attach themselves to impurities of all kinds in the body of water as desired and slowly convey said impurities to the water surface.

In an embodiment, the base wall and side wall delimit the microbubble stabilization zone from the surrounding water. To this end, they can in particular form a pot-like container which is open at the top. However, this delimitation does not have to be complete either to the sides or to the bottom, since a certain exchange with the surrounding water body can be acceptable.

In an embodiment, the microbubble stabilization zone has a diameter which is ten times an inner diameter of the pressurized water line or more. For example, the diameter of the microbubble stabilization zone can lie in the range from approximately 10 cm to approximately 100 cm. The height of the microbubble stabilization zone, which can correspond to the height of the side wall or the distance between the base wall and the upper edge of the side wall, can likewise lie within the range from approximately 10 cm to approximately 100 cm. Experiments have revealed that when a microbubble stabilization zone of the indicated size is used, microbubbles can be produced particularly efficiently. It goes without saying that the microflotation system can have several expansion valves. In this case, each expansion valve can be assigned its own microbubble stabilization zone having a base wall and side wall. It is likewise possible to arrange several expansion valves inside a common microbubble stabilization zone. In this case, the use of a larger microbubble stabilization zone can be advantageous.

In an embodiment, the side wall has an upper edge which is arranged at a predefined water depth above the expansion valve. Consequently, a continuous exchange with the surrounding water body can be effected above the microbubble stabilization zone.

In an embodiment, the expansion valve has an outlet opening which is arranged on an upper side of the base wall. In particular, the outlet opening can be arranged in the middle of the base wall. This outlet opening can be a valve gap of the expansion valve. However, due to the design, the valve gap of the expansion valve is frequently located within a housing of the expansion valve, and joins a short line section inside the expansion valve housing, which leads up to the outlet opening. Ideally, the outflowing gas/water mixture should flow into the microbubble stabilization zone as soon as possible after passing through the valve gap. An arrangement of the outlet opening (directly) on an upper side of the base wall or in the base wall itself is particularly advantageous for this.

In an embodiment, at least one supply opening is configured in the base wall and/or in the side wall, through which water can flow out of the water body into the microbubble stabilization zone. A moderate inflow of contaminated water through the supply opening into the microbubble stabilization zone can be useful so that the microbubbles, once they are stably formed, can attach themselves to impurities at an early stage. However, the supply opening should be dimensioned so that only a little surrounding water flows in, in proportion to the volume flow of the gas/water mixture introduced into the microbubble stabilization zone. For example, the at least one supply opening can be dimensioned so that approximately the same quantity of surrounding water flows in as the gas/water mixture through the outlet opening of the expansion valve. Otherwise, the described, advantageous effects of the delimitation of the microbubble stabilization zone cannot be achieved or cannot be achieved to an optimal degree.

In an embodiment, several of the supply openings are configured in the base wall. As a result, the configuration of a flow leading overall from bottom to top can be favored. In an embodiment, a size of the at least one supply opening and/or a number of opened supply openings can be adjusted. As a result, the inflow of surrounding water through the supply opening can be matched to the quantity of pressurized water introduced.

In an embodiment, a baffle plate is arranged in the microbubble stabilization zone above the base wall. In particular, the baffle plate can be aligned parallel to the base wall. The baffle can result in the configuration of an “inner subzone” in the microbubble stabilization zone, which is arranged between the base wall and the baffle plate. A high concentration of the dissolved gas ensues even more quickly in this inner subzone, as a result of which the efficiency of the microbubble formation can be increased once again. At the same time, the baffle plate can prevent the microbubbles from rising too quickly.

In an embodiment, a distance between the baffle plate and the base wall is 50% or less of a height of the side wall. Experiments have revealed that this is helpful for efficient microbubble production.

In an embodiment, the microflotation system has a floating body, which is connected to the supporting structure, such that the microflotation system can be utilized in a floating manner. In particular, it can thus drift on the surface of the body of water, that is to say float freely. However, it can also be maintained in a specific position or, optionally, be moved with a drive.

In an embodiment, the microflotation system has a hydrogen storage device and a hydrogen-operated fuel cell. In this way, the energy requirement of the microflotation system (substantially continually required electrical power to operate the pressure apparatus for producing the pressurized water) can be provided in an environmentally friendly manner. Impurities in the body of water, for example due to leaking fuel when using a diesel unit, cannot occur at all.

In an embodiment, the hydrogen storage system is arranged in, or forms, the floating body. Hydrogen storage systems are available in marine grade versions for use on board ships. Due to the low specific density of the hydrogen stored therein, such hydrogen storage systems are ideally suited as floating bodies.

In an embodiment, the body of water is a natural body of water, in particular a lake, a river or a sea. The utilization of a floating microflotation system is ideal for natural bodies of water, because there is no requirement for a permanent intervention in the ecosystem which is, in many cases, sensitive. In particular, the banks and the bottom of the body of water can remain untouched to the greatest possible extent.

In an embodiment, the body of water is an artificial body of water, in particular a pond, a canal or a retention basin for rain or flood waters. The water bodies of the indicated artificial bodies of water typically have very large volumes of, for example, 1000 m3 or more, which makes it necessary to configure a microbubble stabilization zone according to the invention.

In an embodiment, the microflotation system has a position monitoring system and a travel drive as well as a controller connected to both, which is configured to maintain the microflotation system in a first position for a first predefined period of time, to subsequently move it to a second position and maintain it there for a second predefined period of time. In particular, the position monitoring system can be a satellite navigation system such as GPS. The travel drive can, in particular, be an electric travel drive with a propeller arranged underwater. In the case of a flowing body of water, the first position and the second position can be understood to be relative to the flowing water. In this case, the microflotation system drifts along with the flowing water during the first predefined period of time in order to subsequently be moved to a different position. In the case of a stationary body of water, the first and second positions can be determined relative to a bottom of the body of water. In both cases, a specific partial volume of the body of water is cleaned during the predefined periods of time in each case. That is to say that, in both cases (flowing water or standing water), a quasi-stationary operation is achieved, in which specific partial volumes of the water body are treated for predefined times.

### BRIEF DESCRIPTION OF THE DRAWINGS

The invention is explained in greater detail below on the basis of an exemplary embodiment depicted in a FIGURE.

FIG. 1 schematically shows an embodiment of a microflotation system.

### DETAILED DESCRIPTION OF THE INVENTION

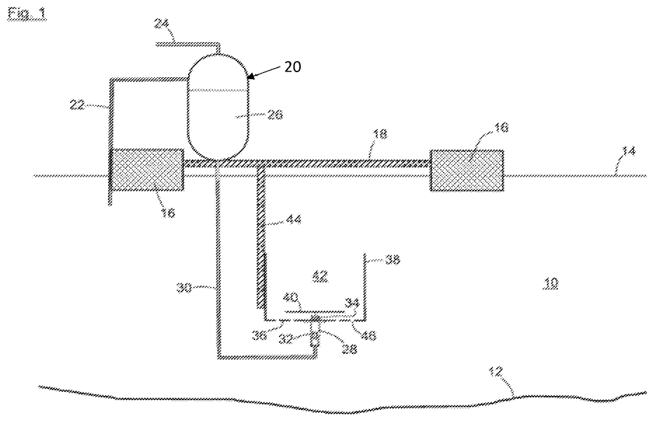

The microflotation system from FIG. 1 is arranged, in a floating manner, on a natural body of water. The body of water has a water body 10, a water bed 12 and a water surface 14.

The microflotation system has two floating bodies 16 and a supporting structure 18 which connects the floating bodies 16 to one another, such that the entire microflotation system can float on the water surface 14. A pressure apparatus for producing pressurized water comprises a pressure vessel 20, to which water can be supplied continuously from the water body 10 via a supply line 22, the free end of which is arranged beneath the water surface 14. To this end, a pump (not depicted) can be arranged in the supply line 22. In addition, a gas line 24, which is only suggestively depicted, opens into the pressure vessel 20. A compressor (not depicted) can be arranged in this gas line 24. Air can be supplied continuously to the pressure vessel 20 via the gas line 24. An elevated pressure prevails in the pressure vessel 20, for example in the range from 2 bar to 10 bar, which leads to the gases contained in the air being dissolved in the water. The resulting pressurized water 26 is ideally enriched with the gases contained in the air up to a saturation concentration.

An expansion valve 28 is arranged beneath the water surface 14. The expansion valve 28 is maintained at a predefined water depth via a downwardly pointing section 44 of the supporting structure 18 which is connected to the side wall 38 and via the latter to the base wall 36. The expansion valve 28 is connected to the pressure vessel 20 via a pressurized water line 30. Inside the expansion valve 28, there is located a valve gap 32 at which the explained pressure release process takes place. Due to the configuration, in the case of the expansion valve 28 depicted by way of example, the valve gap 32 is located approximately in the middle of a valve housing. At an upper end, the valve housing of the expansion valve 28 has several outlet openings 34, at which the gas/water mixture flows out of the housing of the expansion valve 28 shortly after the expansion.

The outlet openings 34 of the expansion valve 28 are located immediately above a base plate 36 which is arranged horizontally and the expansion valve 28 is arranged in the middle thereof. The edge of the base plate 36 is connected to a circumferential side wall 38 which is aligned vertically. The base plate 36 with the side wall 38 delimits a microbubble stabilization zone 42 arranged in its interior from the surrounding water body 10. A baffle plate 40, which is located at a relatively small distance from the base wall 36, is arranged above the base plate 36 and parallel thereto. The diameter of the baffle plate 40 is approximately half a diameter of the base wall 36 such that a relatively wide, circular disk-shaped passage is formed on the side of the baffle plate 40.

Microscopically small gas bubbles are configured or formed in the pressurized water 26 immediately after passing through the valve gap 32. The gas/water mixture flows quickly through the outlet openings 34 into the microbubble stabilization zone 42, where stable microbubbles are configured, beginning in the region between the base wall 36 and the baffle plate 40. This process continues during the slow rise through the microbubble stabilization zone 42 such that a plurality of stable microbubbles is available at the height of the upper edge of the side wall 38, which continue to rise towards the water surface 14 and thereby attach themselves to impurities present in the water body 10 and carry these with them to the water surface 14. The flotate configured there can be easily removed, for example with the aid of a conveying apparatus and/or by being sucked off at the water surface 14.

Presumably, the microbubble stabilization zone achieves its beneficial effect on the configuration of stable microbubbles by reducing the concentration gradient of the dissolved gases in the vicinity of the expansion valve. For example, the concentration of the dissolved oxygen in the water body can lie in the range of approximately 7 mg/l. A higher concentration of, by way of example, approximately 25 mg/l quickly ensues in the microbubble stabilization zone.

### LIST OF REFERENCE NUMERALS

10 Water body
12 Water bed
14 Water surface
16 Floating body
18 Supporting structure
20 Pressure vessel
22 Supply line
24 Gas line
26 Pressurized water
28 Expansion valve
30 Pressurized water line
32 Valve gap
34 Outlet opening
36 Base wall
38 Side wall
40 Baffle plate
42 Microbubble stabilization zone
44 Section of the supporting structure
46 Supply opening

1-12. (canceled)

13. A microflotation system, comprising:
an pressure apparatus configured to produce pressurized water;
an expansion valve positioned at a predefined water depth in a body of water;
a pressurized water line configured to connect the pressure apparatus to the expansion valve;
a floating body;
a supporting structure connected to the floating body and structured to maintain the expansion valve at the predefined water depth;
a base wall coupled to the supporting structure and positioned below a surface of the body of water; and
a circumferential side wall connected to the base wall,
wherein the microflotation system is configured to treat the body of water, and
wherein a microbubble stabilization zone is positioned downstream of the expansion valve and at least partially delimited from the body of water by the base wall and the circumferential side wall.

14. The microflotation system according to claim 13, wherein the microbubble stabilization zone comprises a diameter at least ten times greater than an inner diameter of the pressurized water line.

15. The microflotation system according to claim 13, wherein the side wall comprises has an upper edge positioned at a predefined water depth above the expansion valve.

16. The microflotation system according to claim 13, wherein the expansion valve comprises an outlet opening positioned on an upper side of the base wall.

17. The microflotation system according to of claim 13, further comprising at least one supply opening defined in one of: (i) the base wall; and (ii) the side wall, wherein the at least one supply opening is dimensioned to enable water to flow into the microbubble stabilization zone.

18. The microflotation system according to claim 17, wherein the at least one supply opening comprises a diameter.

19. The microflotation system according to claim 13, further comprising a baffle plate positioned in the microbubble stabilization zone and above the base wall.

20. The microflotation system according to claim 19, wherein a distance between the baffle plate and the base wall is 50% or less of a height of the side wall.

21. The microflotation system according to claim 13, wherein the body of water comprises a natural body of water.

22. The microflotation system according to claim 21, wherein the body of water is one of: (i) a lake; (ii) a river; and (iii) a sea.

23. The microflotation system according to claim 13, wherein the body of water comprises an artificial body of water.

24. The microflotation system according to claim 23, wherein the body of water is one of: (i) a pond; (ii) a canal; and (iii) a retention basin for rain or flood waters.

25. The microflotation system according to claim 13, further comprising:
a position monitoring system;
a travel drive; and
a controller in communication with the positioning monitoring system and the travel drive, wherein the controller is configured to maintain the microflotation system in a first position for a first predefined period of time, and wherein the controller is further configured to subsequently move the microflotation system to a second position and maintain the second position for a second predefined period of time.
